(19) United States
(12) Patent Application Publication
(10) Pub. No.: US 2026/0244014 A1
(43) Pub. Date: Aug. 20, 2026

(54) WINDSHIELD GLASS AND HEAD-UP DISPLAY SYSTEM

(71) Applicant: FUJIFILM Corporation, Tokyo (JP)

(72) Inventor: Akihiro ANZAI, Minamiashigara-shi (JP)

(73) Assignee: FUJIFILM Corporation, Tokyo (JP)

(21) Appl. No.: 19/640,467

(22) Filed: Apr. 7, 2026

Related U.S. Application Data
(63) Continuation of application No. PCT/JP2024/037678, filed on Oct. 23, 2024.

(30) Foreign Application Priority Data
Nov. 6, 2023 (JP) 2023-189398
Aug. 21, 2024 (JP) 2024-139656

(51) Int. Cl. G02B 27/01; B32B 17/10; B60J 1/00; B60J 1/02; B60K 35/231

(52) U.S. Cl. CPC G02B 27/0101; B32B 17/10036; B32B 17/10541; B60J 1/001; B60J 1/02; B60K 35/231; B32B 2307/416; B32B 2605/00; B60K 2360/23; B60K 2360/25

(57) ABSTRACT

Provided are a windshield glass and a head-up display system in which double images are suppressed even in a case where s-polarized light and p-polarized light are mixed in light incident on the windshield glass in a head-up display. A windshield glass includes: an outer glass plate; a reflective layer consisting of a plurality of layers; a retardation layer; an interlayer; and an inner glass plate, wherein a front retardation of the retardation layer at a wavelength of 550 nm is 280 nm or more and 400 nm or less, and an angle between a direction of a slow axis of the retardation layer and a vertical direction of the windshield glass is 1° or more and 20° or less, or 91° or more and 110° or less.

### CROSS-REFERENCE TO RELATED APPLICATIONS

This application is a Continuation of PCT International Application No. PCT/JP2024/037678 filed on Oct. 23, 2024, which claims priority under 35 U.S.C. § 119(a) to Japanese Patent Application No. 2023-189398 filed on Nov. 6, 2023 and Japanese Patent Application No. 2024-139656 filed on Aug. 21, 2024. The above applications are hereby expressly incorporated by reference, in their entirety, into the present application.

### BACKGROUND OF THE INVENTION

### 1. Field of the Invention

The present invention relates to a windshield glass having a reflective layer and a head-up display system.

### 2. Description of the Related Art

Recently, it is known as a so-called head-up display or head-up display system for providing various pieces of information such as maps, traveling speed, and vehicle conditions to a driver or the like by projecting screen images on a windshield glass of a vehicle or other moving objects.

With the head-up display system, virtual images of images including the above described various pieces of information projected on the windshield glass are observed by the driver or the like. An image formation position of the virtual image is located in front of the vehicle's outer side with respect to the windshield glass. The image formation position of the virtual image is usually located on a front side with respect to the windshield glass by 1000 mm or more, and is located on an outer side with respect to the windshield glass. Therefore, the driver can obtain the above-described various pieces of information while looking at the outside world in front without moving the line of sight significantly. Accordingly, in a case of using the head-up display system, it is expected to drive more safely while obtaining various pieces of information.

The head-up display system can be configured to form a reflection film on the windshield glass using a half-mirror film. Various half-mirror films that can be used in the head-up display system are proposed.

WO2021/200652A discloses a head-up display system including a reflective layer in which an optically anisotropic layer and an optically isotropic layer are combined, and capable of reflecting a part of p-polarized light.

The windshield glass constituting the head-up display system is required to be free from double images. In the method of WO2021/200652A, by using a head-up display system in which p-polarized light is incident on the windshield glass, the reflectance of the windshield glass at the air interface on the vehicle outside is reduced, and the double image is made difficult to be visible.

### SUMMARY OF THE INVENTION

Here, in the in-vehicle head-up display system, even in a case where p-polarized light is incident on the windshield glass, the s-polarized light component may be mixed due to the disposition of the mirror or the like. In some cases, the ratio of the s-polarized light component is 10% or more, and thus there is a problem in that the double image is easily visible. Therefore, even in a case where the s-polarized light component is mixed in the light incident on the windshield glass, it is required that the double image is not visible.

An object of the present invention is to provide a windshield glass and a head-up display system capable of suppressing a double image in a case where s-polarized light is included in light incident on the windshield glass.

In the present invention, a double image is improved by forming a reflective layer of the windshield glass and a suitable retardation layer. Specifically, the above-described object is achieved by the following means.
[1] A windshield glass comprising:
an outer glass plate;
a reflective layer consisting of a plurality of layers;
a retardation layer; an interlayer; and
an inner glass plate,
in which a front retardation of the retardation layer at a wavelength of 550 nm is 280 nm or more and 400 nm or less, and
an angle between a direction of a slow axis of the retardation layer and a vertical direction of the windshield glass is 1° or more and 20° or less, or 91° or more and 110° or less.
[2] The windshield glass according to [1],
in which the front retardation of the retardation layer at a wavelength of 550 nm is 320 nm or more and 350 nm or less.
[3] The windshield glass according to [1] or [2],
in which the angle between the direction of the slow axis of the retardation layer and the vertical direction of the windshield glass is 2° or more and 10° or less, or 92° or more and 100° or less.
[4] The windshield glass according to any one of [1] to [3],
in which the reflective layer and the retardation layer are disposed between the outer glass plate and the inner glass plate, and
the retardation layer is disposed on an inner glass plate side with respect to the reflective layer.
[5] The windshield glass according to any one of [1] to [3],
in which the reflective layer and the retardation layer are disposed between the outer glass plate and the inner glass plate, and
the retardation layer is disposed on an outer glass plate side with respect to the reflective layer.
[6] The windshield glass according to any one of [1] to [3],
in which the reflective layer and the retardation layer are disposed on a surface side of the inner glass plate opposite to the outer glass plate, and
the retardation layer is disposed at a position spaced apart from the inner glass plate with respect to the reflective layer.
[7] The windshield glass according to any one of [1] to [3],
in which the reflective layer and the retardation layer are disposed on a surface side of the inner glass plate opposite to the outer glass plate, and
the retardation layer is disposed on an inner glass plate side with respect to the reflective layer.
[8] The windshield glass according to any one of [1] to [7],
in which the reflective layer is a reflective layer in which an inorganic layer is laminated.
[9] The windshield glass according to any one of [1] to [7],
in which the reflective layer is a linearly polarized light reflection layer consisting of alternate lamination of an optically anisotropic layer and an optically isotropic layer.
[10] A head-up display system comprising:
the windshield glass according to any one of [1] to [9]; and
a projector that irradiates an inner glass plate side of the windshield glass with projected light.
[11] The head-up display system according to [10],
in which the projected light of the projector includes an s-polarized light component and a p-polarized light component, and
a ratio of the s-polarized light component is 10% or more and 40% or less.

According to the present invention, it is possible to provide a windshield glass and a head-up display system in which double images are restrained even in a case where incident ray in which an s-polarized light component is mixed with a p-polarized light component is used.

### BRIEF DESCRIPTION OF THE DRAWINGS

FIG. 1 is a schematic view showing an example of a windshield glass according to an embodiment of the present invention.

FIG. 2 is a schematic view of a linearly polarized light reflection film as seen from the front.

FIG. 3 is a schematic view showing an example of a head-up display having the windshield glass according to the embodiment of the present invention.

FIG. 4 is a schematic view showing an s-polarized light ratio of incident ray.

FIG. 5 is a view for describing an angle of a slow axis.

FIG. 6 is a schematic view showing another example of the windshield glass according to the embodiment of the present invention.

FIG. 7 is a schematic view showing another example of the windshield glass according to the embodiment of the present invention.

FIG. 8 is a schematic view showing another example of the windshield glass according to the embodiment of the present invention.

### DESCRIPTION OF THE PREFERRED EMBODIMENTS

Hereinafter, the windshield glass and the head-up display system according to embodiments of the present invention will be described in detail based on suitable embodiments shown in the accompanying drawings.

The drawings illustrated below are merely examples for describing the present invention, and the present invention is not limited to the drawings illustrated below.

Hereinafter, the expression “to” indicating a numerical range includes numerical values written on both sides of “to”. For example, in a case where ε₁ is a numerical value α₁ to a numerical value β₁, the range of ε₁ is a range including the numerical value α₁ and the numerical value β₁, and it is expressed as α₁≤ε₁≤β₁ in mathematical symbols.

Angles such as “angles represented by specific numerical values”, “parallel”, “vertical”, and “orthogonal” include error ranges generally tolerated in the art, unless otherwise described.

In addition, “same” includes an error range generally tolerated in the art, and “entire surface” and the like also include error ranges generally tolerated in the art.

“light” means light of visible light and natural light (unpolarization), unless otherwise specified. The visible light is light at a wavelength which is visible to the human eyes, among electromagnetic waves, and is normally light in a wavelength range of 380 to 780 nm. Invisible light is light in a wavelength range of smaller than 380 nm or in a wavelength range of greater than 780 nm.

Although light is not limited thereto, among the visible light, the light in a wavelength range of 420 to 490 nm is blue (B) light, and the light in a wavelength range of 495 to 570 nm is green (G) light, the light in a wavelength range of 620 to 750 nm is red (R) light.

The term “visible light transmittance” is a visible light transmittance of an A light source defined in JIS (Japanese Industrial Standards) R 3212:2015 (Test methods of safety glazing materials for road vehicles). That is, the transmittance is obtained by measuring a transmittance of each wavelength in a range of 380 to 780 nm with a spectrophotometer using the A light source, and multiplying a wavelength distribution of International Commission on Illumination (CIE) standard relative luminosity factor for light adaptation and weighting functions obtained from a wavelength interval by the transmittance at each wavelength, and performing a weighted average.

In a case of simply referring to “reflected light” or “transmitted light”, the “reflected light” and “transmitted light” include meanings of “scattered light” and “diffracted light”, respectively.

p-polarization means polarization that vibrates in a direction parallel to an incident surface of light. The incident surface means a surface that is perpendicular to a reflecting surface (such as a windshield glass surface) and includes an incident ray and a reflected ray. The p-polarized light has an electric field vector whose vibration surface is parallel to the incident surface.

The term “projection image” means an image based on projection of light from a projector to be used, which is not a scenery viewed from the driver's position such as in front of the driver. The projection image is observed by an observer as a virtual image that appears over a reflection film of the windshield glass.

The term “screen image” means an image displayed on a drawing device of a projector or an image drawn on an intermediate image screen or the like by a drawing device. In contrast to a virtual image, the screen image is a real image.

Both the screen image and the projection image may be monochrome images, may be multicolor images with two or more colors, or may be full color images.

In the present invention, a front retardation Re(λ) and a thickness direction retardation Rth(λ) represent an in-plane retardation and a thickness direction (film thickness direction) retardation at a wavelength λ, respectively. Unless otherwise specified, it is assumed that the wavelength λ is 550 nm.

In the present invention, Re(λ) and Rth(λ) are values measured at the wavelength λ in AxoScan OPMF-1 (manufactured by Opto Science, Inc.). By inputting the average refractive index ((Nx+Ny+Nz)/3) and the film thickness (d (μm)) to AxoScan,
a slow axis direction (°),
Re(λ)=R0(λ), and
Rth(λ)=((Nx+Ny)/2−Nz)×d is calculated.

In the present invention, the refractive indices Nx, Ny, and Nz are measured with an Abbe refractometer (NAR-4T, manufactured by Atago Co., Ltd.) using a sodium lamp (λ=589 nm) as a light source.

In addition, in a case of measuring wavelength dependence, it can be measured with a multi-wavelength Abbe refractometer DR-M2 (manufactured by Atago Co., Ltd.) in combination with a dichroic filter.

In addition, values from Polymer Handbook (John Wiley & Sons, Inc.) and catalogs of various optical films can also be used. Examples of average refractive index values of main optical films are as follows: cellulose acylate (1.48), a cycloolefin polymer (1.52), polycarbonate (1.59), polymethyl methacrylate (1.49), and polystyrene (1.59).

### [Windshield Glass]

The windshield glass according to the embodiment of the present invention includes
an outer glass plate, a reflective layer consisting of a plurality of layers, a retardation layer, an interlayer, and an inner glass plate,
in which a front retardation of the retardation layer at a wavelength of 550 nm is 280 nm or more and 400 nm or less, and
an angle between a direction of a slow axis of the retardation layer and a vertical direction of the windshield glass is 1° or more and 20° or less, or 91° or more and 110° or less.

The term “windshield glass” means general window glass and windshield glass for vehicles such as cars and trains, and vehicles such as airplanes, ships, motorcycles, and playground equipment. The windshield glass is preferably used as a front glass, a windshield, or the like in front of the vehicle in a traveling direction.

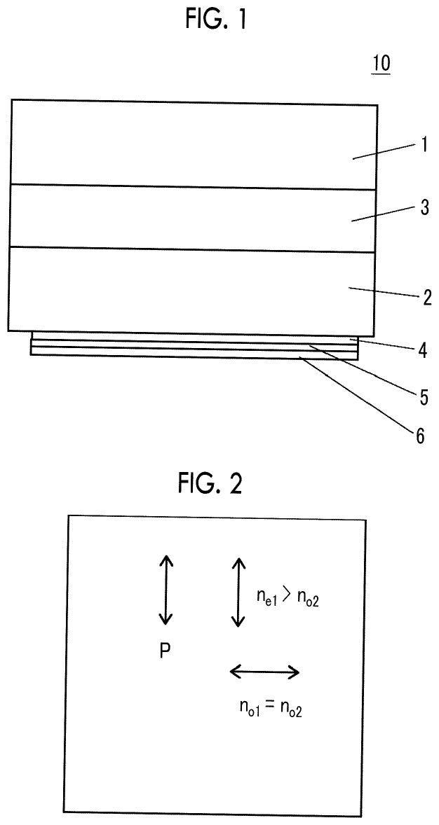

FIG. 1 illustrates an example of the windshield glass.

In a case where the windshield glass according to the embodiment of the present invention is used in a vehicle, the outer glass plate 1 and the inner glass plate 2 are often used as curved glass. In this case, in a case where the inner glass plate 2 is set as the inside of the vehicle and the outer glass plate 1 is set as the outside of the vehicle, the inner glass plate 2 is disposed such that a convex surface side faces the outer glass plate 1, and the outer glass plate 1 is disposed such that a concave surface side faces the inner glass plate 2.

In a case where the inner glass plate 2 and the outer glass plate 1 are curved glasses, in the example shown in FIG. 1, a retardation layer 6 is disposed on a concave surface side of the inner glass plate 2 with a reflective layer 4 and an adhesion layer 5 interposed therebetween. That is, the example shown in FIG. 1 is an example in which the reflective layer 4 and the retardation layer 6 are laminated on a surface side of the inner glass plate 2 opposite to the outer glass plate 1, and the retardation layer 6 is disposed at a position spaced from the inner glass plate 2 with respect to the reflective layer 4. Therefore, the retardation layer 6 is disposed on the inside of the vehicle with respect to the reflective layer 4.

Such a windshield glass 10 is used in a head-up display system, and projected light from a projector is emitted from the inside of the vehicle to the reflective layer 4 of the windshield glass 10, and a part of the projected light is reflected by the reflective layer 4 to display an image (virtual image) to a driver. Since the windshield glass 10 needs to have a high visible light transmittance, a reflectance of the reflective layer 4 is about 30% or less, and most of the emitted projected light is transmitted through the windshield glass 10. In the case of the example shown in FIG. 1, the projected light is incident on the retardation layer 6 before being incident on the reflective layer 4.

There is no limit to the visible light transmittance of the windshield glass, but a higher value is preferable. The visible light transmittance of the windshield glass is preferably 70% or more, more preferably more than 70%, still more preferably 75% or more, and particularly preferably 80% or more.

The above described visible light transmittance is preferably satisfied at any position of the windshield glass, and particularly, the above described visible light transmittance is preferably satisfied at a position where the reflection film (reflective layer 4) is present.

In the windshield glass according to the embodiment of the present invention, it is preferable that the reflective layer reflects linearly polarized light. However, the reflective layer does not need to selectively reflect specific polarized light. In a case where the reflective layer is incorporated in the windshield glass and used as a combiner for a head-up display, the projected image light is preferably p-polarized light, that is, linearly polarized light in order to prevent reflection on the surface of the windshield glass.

A shape of the windshield glass is not limited, and is appropriately determined according to a target on which the windshield glass is disposed. The windshield glass may be, for example, a flat surface or a three-dimensional shape having a curved surface such as a concave surface or a convex surface. In the windshield glass formed for a vehicle to be applied, a surface on which a direction (vertical direction) which is upward in normal use, an observer side, a driver side (left-right direction), a visible side such as an in-vehicle side, and an outside of the vehicle are specified can be specified.

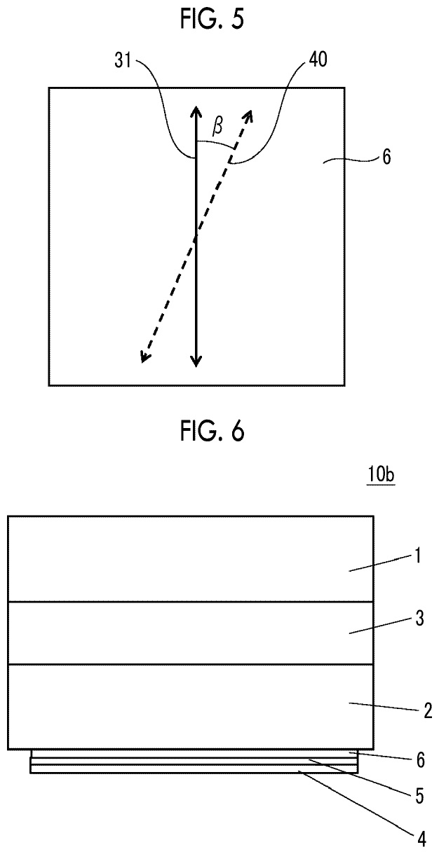

Here, in the windshield glass 10 according to the embodiment of the present invention, a front retardation of the retardation layer 6 at a wavelength of 550 nm is 280 nm or more and 400 nm or less, and an angle between a direction of a slow axis of the retardation layer 6 and a vertical direction of the windshield glass 10 is 1° or more and 20° or less, or 91° or more and 110° or less. In the present specification, the vertical direction of the windshield glass 10 is a direction along a surface of the windshield glass 10 in a vertical direction (vertical direction) in the windshield glass 10 in normal use. FIG. 5 shows a vertical direction 31 of the windshield glass 10, a direction 40 of the slow axis of the retardation layer 6, and an angle (angle of the slow axis) β therebetween.

As described above, in the head-up display system, it is considered that, by causing p-polarized light to be incident into the windshield glass, a reflectance of the windshield glass at an air interface on the outside of the vehicle is reduced, and a double image is made less visible. However, in the head-up display system, light from a projector is reflected by a mirror or the like to be incident into the windshield glass 10 through a predetermined optical path. Therefore, due to a deviation in a position or an angle of the mirror, linearly polarized light incident into the windshield glass 10 may deviate from ideal p-polarized light, and an s-polarized light component may be mixed. In a case where the s-polarized light component is mixed in the linearly polarized light incident into the windshield glass 10, a reflectance of light transmitted through the reflective layer 4 and reaching the air interface of the outer glass plate 1 is higher than that in a case where only the p-polarized light component is present, and a part of the light is reflected. Therefore, the double image is likely to be visible.

On the other hand, the windshield glass 10 according to the embodiment of the present invention includes the retardation layer 6, and the projected light passes through the retardation layer 6 before reaching the air interface of the outer glass plate 1. In this case, since the front retardation of the retardation layer 6 and the angle of the slow axis satisfy the above-described ranges, linearly polarized light in which the s-polarized light component is mixed can be converted into a polarization state closer to p-polarized light. Therefore, the reflectance of light reaching the air interface of the outer glass plate 1 can be reduced. Therefore, reflection at the air interface of the outer glass plate 1 can be suppressed, and the double image can be reduced.

In the windshield glass 10 according to the embodiment of the present invention, the retardation layer 6 in which the front retardation and the angle of the slow axis satisfy the above-described ranges can more effectively convert light including the s-polarized light component at a ratio of 10% or more and 40% or less, more preferably 12% or more and 30% or less, into a state closer to p-polarized light, and the double image can be further reduced.

In the windshield glass, the reflective layer and the retardation layer may be provided in a projection image display portion (projection image reflection portion) of the windshield glass.

In addition, in the windshield glass, the reflective layer and the retardation layer may be provided between the glasses of the windshield glass having a laminated glass configuration, or may be provided on the outer surface of the glass plate of the windshield glass.

In a case where the reflective layer and the retardation layer are provided on the outer surface of the glass plate of the windshield glass, the reflective layer and the retardation layer may be provided inside the vehicle or the like (on the incidence side of the projection image) or may be provided outside.

For example, in the windshield glass 10b shown in FIG. 6, the reflective layer 4 and the retardation layer 6 are disposed on the surface side of the inner glass plate 2 opposite to the outer glass plate 1, and the retardation layer 6 is disposed on the inner glass plate 2 side with respect to the reflective layer 4. Therefore, the retardation layer 6 is disposed on the outside of the vehicle with respect to the reflective layer 4.

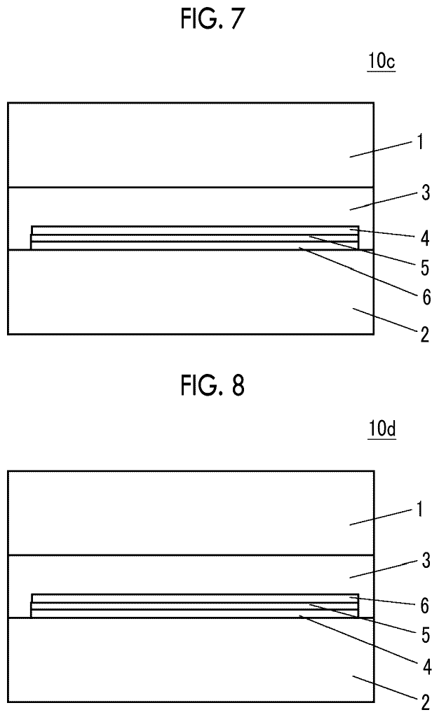

In addition, in the windshield glass 10c shown in FIG. 7, the reflective layer 4 and the retardation layer 6 are disposed between the outer glass plate 1 and the inner glass plate 2, and the retardation layer 6 is disposed on the inner glass plate 2 side with respect to the reflective layer 4. Therefore, the retardation layer 6 is disposed on the inside of the vehicle with respect to the reflective layer 4.

In addition, in the windshield glass 10d shown in FIG. 8, the reflective layer 4 and the retardation layer 6 are disposed between the outer glass plate 1 and the inner glass plate 2, and the retardation layer 6 is disposed on the outer glass plate 1 side with respect to the reflective layer 4. Therefore, the retardation layer 6 is disposed on the outside of the vehicle with respect to the reflective layer 4.

In the examples shown in FIGS. 7 and 8, the reflective layer 4, the adhesion layer 5, and the retardation layer 6 are disposed to be laminated on the surface of the inner glass plate 2 on the outer glass plate 1 side, but the present invention is not limited thereto, and the reflective layer 4, the adhesion layer 5, and the retardation layer 6 may be disposed on the surface of the outer glass plate 1 on the inner glass plate 2 side. Alternatively, the reflective layer 4 and the retardation layer 6 may be interposed between the outer glass plate 1 and the inner glass plate 2 with the interlayer 3. In addition, one of the reflective layer 4 and the retardation layer 6 may be disposed on the surface of the inner glass plate 2 on the outer glass plate 1 side, and the other may be disposed on the surface of the outer glass plate 1 on the inner glass plate 2 side. Alternatively, one of the reflective layer 4 and the retardation layer 6 may be disposed between the outer glass plate 1 and the inner glass plate 2, and the other may be disposed on the outer surface of the glass plate.

In a case where a reflective layer that reflects linearly polarized light (p-polarized light) is used as the reflective layer 4, it is preferable that the retardation layer 6 is disposed on the inside of the vehicle with respect to the reflective layer 4 (configuration of FIGS. 1 and 6). As a result, the projected light is incident on the retardation layer 6 before being incident on the reflective layer 4, and thus the projected light is converted into a state close to p-polarized light by the retardation layer 6 and then is incident on the reflective layer 4. Therefore, the p-polarized light is likely to be reflected by the reflective layer 4, and the brightness of the display image can be increased.

The reflective layer and the retardation layer may be provided on the entire surface of the windshield glass, or may be provided on a part of the windshield glass in a plane direction; but is preferably provided on a part of the windshield glass.

In a case where the reflective layer and the retardation layer are provided on a part of the windshield glass, the reflective layer and the retardation layer may be provided at any position of the windshield glass, but it is preferable that the reflective layer and the retardation layer are provided such that a virtual image is shown at a position that is easily visible from an observer such as a driver during use as a HUD. For example, a position where the reflective layer and the retardation layer are provided in the windshield glass may be determined from a relationship between a position of a cab seat in a vehicle on which the HUD is mounted and a position where the projector is installed.

Hereinafter, the configuration components of the windshield glass according to the embodiment of the present invention will be described.

### <Reflective Layer>

The reflective layer is formed of a dielectric layer (dielectric multi-layer film) consisting of a laminate of a high-refractive-index inorganic layer and a low-refractive-index inorganic layer or a dielectric layer having linearly polarized light reflectivity consisting of an alternate laminate of an optically anisotropic layer and an optically isotropic layer. It is preferable that the reflectance of the reflective layer at an incidence angle of 0° is low because the transmittance of the windshield glass is increased. It is preferable that the reflectance at an incidence angle of 65° is high because the visibility of the HUD image is high.

In addition, it is desirable that the reflective layer is configured to control the phase by the refractive index and the film thickness of each layer such that the p-polarized light reflection at an incidence angle of 65° is large.

As the dielectric layer consisting of a laminate of a high-refractive-index inorganic layer and a low-refractive-index inorganic layer and the linearly polarized light reflection layer consisting of an alternate laminate of an optically anisotropic layer and an optically isotropic layer, known configurations in the related art can be appropriately used.

### (Inorganic Layer)

The high-refractive-index inorganic layer and the low-refractive-index inorganic layer are formed by vapor-phase film formation such as magnetron sputtering, and are formed of a dielectric layer such as ZnSnMgOx, ZnSnOx, ZnO, SnO2, TiO2, Si3N4, SiO2, MgF2, or AlN.

In order to suitably design the optical characteristics of the reflective layer, a metal layer such as Ag may be used as the low refractive index layer.

In the present invention, the dielectric layer may be an alternate layer of a high refractive-index layer and a low refractive index layer having a thickness of 1 to 300 nm, and the phase can be controlled by adjusting the film thickness and the refractive index, and the transmittance and the reflectance can be controlled.

In the present invention, it is preferable that the metal layer and the dielectric layer are configured and formed such that the unpolarized light reflectance at an incidence angle of 0 degrees is reduced and the p-polarized light reflectance at an incidence angle of 65 degrees is increased with respect to the windshield glass.

### (Dielectric Layer Having Linearly Polarized Light Reflectivity)

In the dielectric layer having linearly polarized light reflectivity according to the embodiment of the present invention, a refractive index nₑ₁ in a slow axis direction of the optically anisotropic layer is larger than a refractive index nₒ₂ of the isotropic layer, and a refractive index nₒ₁ in a direction orthogonal to the slow axis of the optically anisotropic layer is substantially the same as the refractive index nₒ₂ of the isotropic layer. A plurality of the optically anisotropic layers are laminated so that the slow axes of the optically anisotropic layers parallel to each other. Therefore, as shown in FIG. 2, in a certain direction (in FIG. 2, the up-down direction), a state where a layer having a high refractive index (nₑ₁) and a layer having a low refractive index (nₒ₂) are laminated is obtained. On the other hand, the layers having the same refractive indexes are laminated in a direction (left-right direction in FIG. 2) orthogonal to this direction.

It is known that a film in which a low refractive index layer (layer of low refractive index) and a layer having a high refractive index (layer of high refractive index) are alternately laminated reflects light having a specific wavelength because of constructive interference between a plurality of layers of low refractive index and layers of high refractive index. Therefore, the dielectric layer having linearly polarized light reflectivity shown in FIG. 2 reflects linearly polarized light in the up-down direction and transmits linearly polarized light in the left-right direction.

As production materials and a production method of the dielectric layer having linearly polarized light reflectivity, for example, those described in JP1997-506837A (JP-H9-506837A) can be used. Specifically, in a case of being processed under conditions selected to obtain a refractive index relationship, a reflective layer can be formed using a wide variety of materials. Usually, a first material is required to have a refractive index different from a second material, in a selected direction. The difference in refractive indices can be achieved by various methods including stretching during film formation or after film formation, extrusion molding, and coating. Furthermore, two materials preferably have similar rheologic properties (for example, melt viscosity) so that the two materials can be coextruded.

Examples of a material that is particularly suitably used as the dielectric layer having linearly polarized light reflectivity include polyethylene naphthalate (PEN) and polyethylene terephthalate (PET) as the optically anisotropic layer, and PEN, PET, and polymethyl methacrylate resin (PMMA) (adjusted to be isotropic) as the isotropic layer.

### <Laminated Glass>

The windshield glass may have a laminated glass configuration. The windshield glass according to the embodiment of the present invention is a laminated glass, and may have the above-described reflective layer between an inner glass plate and an outer glass plate. However, since the reflection of the air interface can be efficiently used, it is preferable that the inner glass plate has a configuration in which the reflective layer is provided.

As a glass plate such as the inner glass plate and the outer glass plate, a glass plate generally used in the windshield glass can be used. For example, a glass plate having a visible light transmittance of 80% or smaller such as 73% or 76%, such as green glass having high thermal insulating properties, may be used.

In addition, the windshield glass is generally rectangular, and the vertical direction is a short side and the horizontal direction is a long side. In the laminated glass according to the embodiment of the present invention, the vertical direction is a short side and the horizontal direction is a long side.

The thickness of the glass plate is not particularly limited, and may be approximately 0.5 to 5.0 mm and is preferably 1.0 to 3.0 mm and more preferably 2.0 to 2.3 mm. Materials or thicknesses of the inner glass plate and the outer glass plate may be the same as or different from each other.

The windshield glass including the laminated glass configuration can be manufactured by using a known manufacturing method of a laminated glass.

In general, the windshield glass can be manufactured by a method of sandwiching the interlayer film for a laminated glass between two glass plates, repeatedly performing a heating treatment and a pressurizing treatment (treatment using rubber rollers, or the like) several times, and finally performing a heating treatment under a pressurizing condition using an autoclave.

### (Interlayer Film)

The interlayer film prevents the glass plate from being broken and scattering in a vehicle in the event of an accident.

As the interlayer film (interlayer film sheet), any known interlayer film used as an interlayer film (interlayer) in the laminated glass can be used. For example, a resin film including a resin selected from the group consisting of polyvinylbutyral (PVB), an ethylene-vinyl acetate copolymer, and a chlorine-containing resin can be used. The above-described resin is preferably a main component of the interlayer film. The main component refers to a component occupying 50% by mass or more of the intermediate film.

Among the resins, polyvinylbutyral and an ethylene-vinyl acetate copolymer are preferable, and polyvinylbutyral is more preferable. The resin is preferably a synthetic resin. Polyvinylbutyral can be obtained by acetalizing polyvinyl alcohol with butyl aldehyde. A preferable lower limit of the degree of acetalizing of the polyvinylbutyral is 40%, a preferable upper limit thereof is 85%, a more preferable lower limit thereof is 60%, and a more preferable upper limit is 75%.

The polyvinyl alcohol is normally obtained by saponification of polyvinyl acetate, and polyvinyl alcohol having a degree of saponification of 80 to 99.8 mol % is generally used. In addition, a preferred lower limit of a degree of the polymerization of polyvinyl alcohol is 200, and a preferred upper limit thereof is 3,000. In a case where the degree of polymerization of polyvinyl alcohol is 200 or more, the penetration resistance of the obtained laminated glass is unlikely to be lowered. In a case where the degree is 3,000 or less, the resin film has good moldability, and the rigidity of the resin film does not become too large.

Thus, a good workability is achieved. A more preferred lower limit thereof is 500 and a more preferred upper limit thereof is 2,000.

Further, a thickness of the interlayer film 36 is not limited, and the thickness depending on the forming materials or the like may be set in the same manner as the interlayer film of the known windshield glass.

### <Retardation Layer>

The retardation layer is not particularly limited as long as the front retardation is 280 nm to 400 nm, and can be appropriately selected depending on the purpose. Examples of the retardation layer include a stretched polycarbonate film, a stretched norbornene-based polymer film, a transparent film in which inorganic particles having birefringence such as strontium carbonate are included and aligned, a thin film in which oblique deposition of an inorganic dielectric is performed on a support, a film in which the polymerizable liquid crystal compound is uniaxially aligned and the alignment is fixed, a film in which the liquid crystal compound is uniaxially aligned and the alignment is fixed, and the like.

Among these, suitable examples of the retardation layer include a film obtained by uniaxially aligning and immobilizing a polymerizable liquid crystal compound.

As an example, the retardation layer can be formed following order. A liquid crystal composition including a polymerizable liquid crystal compound is applied on a temporary support or the surface of the alignment layer, the polymerizable liquid crystal compound in the liquid crystal composition is formed in a nematic alignment in a liquid crystal state, and then the polymerizable liquid crystal compound is immobilized by curing to form the retardation layer.

The retardation layer may be a layer formed by applying a composition including a polymer liquid crystal compound on the temporary support, the surface of the alignment layer or the like, forming the nematic alignment in a liquid crystal state, cooling the composition, and then obtained by immobilizing the alignment.

The thickness of the retardation layer is not limited, but is preferably 0.2 μm to 300 μm, more preferably 0.5 μm to 150 μm, and still more preferably 1.0 μm to 80 μm. The thickness of the retardation layer formed from the liquid crystal composition is not particularly limited, but is preferably 0.2 μm to 10 μm, more preferably 0.5 μm to 5.0 μm, and still more preferably 0.7 μm to 3.0 μm.

In the retardation layer, a front retardation at a wavelength of 550 nm is preferably 280 nm to 400 nm and more preferably 320 nm to 350 nm. By setting the front retardation of the retardation layer within this range, double images can be more suitably suppressed. Rth at this time is preferably about 140 nm to 200 nm.

The retardation layer is disposed such that projected light of a projector is p-polarized light at an air interface of the outer glass plate, and an angle β between a slow axis direction of the retardation layer and a vertical direction of the windshield glass is appropriately set. The angle β is preferably 1° or more and 20° or less, or 91° or more and 110° or less, and more preferably 2° or more and 10° or less, or 92° or more and 100° or less. By setting the angle β within this range, double images can be more suitably suppressed.

### [Head-Up Display System (HUD)]

Next, a head-up display (HUD) having the windshield glass according to the embodiment of the present invention will be described.

The head-up display system according to the embodiment of the present invention is a head-up display system including the windshield glass described above, and a projector that emits projected light onto the inner glass plate side of the windshield glass.

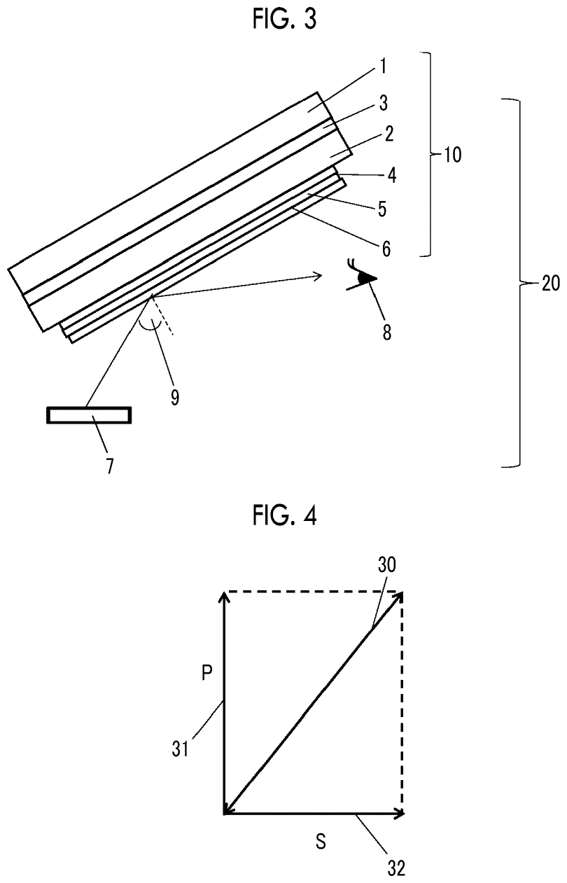

FIG. 3 shows an example of the head-up display system (HUD) according to the embodiment of the present invention.

A HUD 20 illustrated in FIG. 3 includes a windshield glass 10 and a projector 7. The HUD 20 is used in a vehicle such as a passenger car.

In the HUD 20, the projector 7 ideally irradiates the windshield glass 10 with projected light of p-polarized light, but irradiates the windshield glass 10 with projected light including a p-polarized light component and an s-polarized light component. In the following description, light deviating from the ideal including the p-polarized light component and the s-polarized light component is also referred to as p-polarized light. In a case where the projected light with which the projector 7 irradiates the windshield glass 10 is ideal p-polarized light, the reflection of the projected light by the outer glass plate 1 and the inner glass plate 2 of the windshield glass 10 is significantly reduced, and thus inconveniences such as the observation of a double image can be suppressed.

The projector 7 preferably emits the P-polarized projected light to the windshield at the Brewster's angle. As a result, the reflection of the projected light by the outer glass plate 1 and the inner glass plate 2 is eliminated, which allows display of a clearer screen image.

In the HUD 20 according to the embodiment of the present invention, a transmission axis direction of the polarizing plate in a case where the projected light is transmitted through the polarizing plate and appears brightest is defined as the polarization of the projected light. As shown in FIG. 4, the polarization 30 of the projected light is defined as a vector, a direction 31 perpendicular to the windshield glass is defined as a p-polarized light component, and a direction 32 horizontal to the windshield glass is defined as an s-polarized light component. The ratio of the s-polarized light component is obtained as s-polarized light component/(s-polarized light component+p-polarized light component)×100%.

The projector 7 emits the projected light of which the main component is p-polarized light, but the s-polarized light component is mixed in the emitted light due to the influence of the mirror disposition or the like inside the projector, and the ratio of the s-polarized light component is 10% or more.

Therefore, the double image is more likely to be observed as compared with a case where the projected light is only ideal p-polarized light.

On the other hand, in the present invention, as described above, since the windshield glass includes the retardation layer in which the front retardation and the angle of the slow axis satisfy the above-described ranges, the linearly polarized light in which the s-polarized light component is mixed can be converted into a polarization state closer to the ideal p-polarized light. Therefore, the reflection on the air interface of the outer glass plate 1 can be suppressed, and the double image can be reduced.

The present invention is preferably applied in a case where the ratio of the s-polarized light component is 10% or more and 40% or less, and more preferably applied in a case where the ratio of the s-polarized light component is 12% or more and 30% or less.

### <Projector>

The “projector” is a “device projecting light or a screen image”, includes a “device projecting a drawn screen image”, and emits projected light carrying and supporting a screen image to be displayed. In the HUD of the present invention, the projector preferably preferably emits p-polarized projected light.

In the HUD, the projector may be arranged so that the p-polarized projected light carrying and supporting a screen image to be displayed can be incident into the reflection film in the windshield glass at an obliquely incidence angle.

In the HUD, the projector includes a drawing device, and preferably displays, as a virtual image by reflection, a screen image (real image) drawn on a small intermediate image screen using a combiner.

A known projector used for the HUD can be used as long as the projector can emit the projected light of p-polarization. In addition, in the projector, an imaging distance of the virtual image, that is, a virtual image formation position is preferably variable.

Examples of a method of changing an imaging distance of a virtual image in the projector include a method in which a surface (screen) on which a screen image is generated is moved (refer to JP2017-21302A), a method in which a plurality of optical paths having different optical path lengths are changed (refer to WO2015/190157A), a method in which the optical path length is changed by inserting and/or moving mirrors, a method in which the focal length is changed by using a compound lens as an imaging lens, a method in which a projector 22 is moved, a method in which a plurality of projectors having different imaging distances of virtual images are changed and used, and a method in which a variable-focal-length lens is used (refer to WO2010/116912A).

The projector may be a projector in which the imaging distance of the virtual image is continuously changeable or a projector in which the imaging distance of the virtual image can be changed at two or three or more points.

Here, it is preferable that, among the virtual images of the projected light by the projector, at least two virtual images have different imaging distances of 1 m or more. Therefore, in a case where the imaging distance of a virtual image can be continuously changed in the projector, the imaging distance of a virtual image is preferably changeable by 1 m or more. Such a projector is preferably used because the projector can suitably handle a case where the distance of line of sight of the driver is considerably different between a normal speed run on the general road and a high speed run on the expressway.

### (Drawing Device)

The drawing device may itself be a device displaying a screen image or a device emitting light capable of drawing a screen image.

In the drawing device, light from the light source may be adjusted by a drawing method such as an optical modulator, laser luminance modulation unit, optical deflection unit for drawing, or the like. The drawing device includes a light source, and means a device including an optical modulator, laser luminance modulation unit, optical deflection unit for drawing, or the like according to the drawing method.

### (Light Source)

Light sources are not limited, and known light sources used in projectors, drawing devices, and displays, such as light-emitting diodes (LEDs), organic light-emitting diodes (OLEDs), discharge tubes, and laser light sources, may be used.

Among these, the LED or the discharge tube is preferable because they are suitable for a light source of a drawing device which emits linearly polarized light, and the LED is particularly preferable.

### (Drawing Method)

The drawing method can be selected according to a light source to be used, and the like, and is not particularly limited.

Examples of the drawing method include a fluorescent display tube, a liquid crystal display (LCD) method using a liquid crystal, a liquid crystal on silicon (LCOS) method, DLP (Digital Light Processing) (registered trademark) method, a scanning method using a laser, and the like. The drawing method may be a method using a fluorescent display tube integrated with a light source. The LCD method is preferred as the drawing method.

In the LCD method and the LCOS method, light beams having respective colors are modulated and multiplexed by the optical modulator, and a light beam is emitted from a projection lens.

The DLP method is a display system using a digital micromirror device (DMD), in which micromirrors corresponding to the number of pixels are disposed, the drawing is performed and light is emitted from the projection lens.

The scanning method is a method of scanning a screen with light rays and imaging using an afterimage in eyes. For example, the description of JP1995-270711A (JP-H7-270711A) and JP2013-228674A can also be referred to. In the scanning method using the laser, a luminance modulated laser beam having each color of, for example, red light, green light, and blue light may be bundled into one ray of light by a multiplexing optical system or a condenser lens, the scanning may be performed with the ray of light by the optical deflection unit, and the ray of light may be drawn on an intermediate image screen to be described later.

In the scanning method, the luminance modulation of a laser light beam having each color of, for example, red light, green light, and blue light may be performed directly by changing an intensity of the light source, or may be performed by an external modulator. Examples of the optical deflection unit include a galvanometer mirror, a combination of a galvanometer mirror and a polygon mirror, and micro electro mechanical systems (MEMS), and among these, MEMS is preferable. The scanning method includes a random scan method, a raster scan method, or the like, and a raster scan method is preferably used. In the raster scan method, the laser light can be driven, for example, with a resonance frequency in a horizontal direction and with a saw-tooth wave in a vertical direction. Since the scanning method does not require the projection lens, it is easy to miniaturize the device.

Light emitted from the drawing device may be linearly polarized light or natural light (unpolarized light).

In a drawing device using a drawing method of the LCD method or the LCOS method and a drawing device using a laser light source, light emitted from the drawing device is essentially linearly polarized light. In a case where a drawing device in which the emitted light is linearly polarized light and includes light beams having a plurality of wavelengths (colors), polarization directions (transmission axis directions) of the light in a plurality of wavelengths are preferably the same as each other. Known commercially available drawing devices include a device that has non-uniform polarization directions in wavelength ranges of red light, green light, and blue light included in the emitted light (refer to JP2000-221449A). Specifically, as an example, a polarization direction of green light is orthogonal to a polarization direction of red light and a polarization direction of blue light is known.

As described above, in the HUD according to the embodiment of the present invention, the projected light emitted by the projector is preferably p-polarized light.

### (Intermediate Image Screen)

As mentioned above, the drawing device may use an intermediate image screen. The “intermediate image screen” is a screen on which the screen image is drawn. That is, in a case where light emitted from the drawing device is not yet visible as the screen image, the drawing device forms a screen image visible on the intermediate image screen using the light. The screen image drawn on the intermediate image screen may be projected on the combiner by light transmitted through the intermediate image screen, and may be reflected on the intermediate image screen and projected on the combiner.

Examples of the intermediate image screen include a scattering film, a microlens array, and a screen for rear projection. In a case where a plastic material is used as the intermediate image screen, assuming that the intermediate image screen has birefringence, a polarization plane and an intensity of the polarized light incident on the intermediate image screen are in disorder, and color unevenness or the like is likely to occur in the combiner (reflective layer). However, by using a phase difference film having a predetermined phase difference, the problem of occurrence of color unevenness can be reduced.

It is preferable that the intermediate image screen has a function of spreading and transmitting incident ray. This is because an enlarged projection image can be displayed. An example of the intermediate image screen includes a screen composed of a microlens array. The microlens array used in the HUD is described in, for example, JP2012-226303A, JP2010-145745A, and JP2007-523369A.

The projector may include a reflecting mirror which adjusts an optical path of projected light formed by the drawing device.

For the HUD using the windshield glass having a reflective layer, JP1990-141720A (JP-H2-141720A), JP1998-96874A (JP-H10-96874A), JP2003-98470A, U.S. Pat. No. 5,013,134A, JP2006-512622A, and the like can be referred to.

The windshield glass is particularly effective for the HUD used in combination with a projector using lasers, LEDs, or organic light-emitting diodes (OLEDs) in which a luminescence wavelength is not continuous in a visible light region as a light source. In addition, the windshield glass can also be used for projection of a display such as a liquid crystal display device (LCD) in which display light is polarized.

### [Projected Light (Incident Ray)]

It is preferable that the incident ray is incident at an oblique incidence angle of 45° to 70° with respect to a normal line of the reflective layer. A Brewster angle of an interface between glass having a refractive index of about 1.51 and air having a refractive index of 1 is about 56°, and by causing p-polarized light to be incident in the above-described angular range, the amount of incident ray for projection image display reflected on the surface of the windshield glass on the visible side can be reduced, and an image display with a small influence of a double image can be performed.

The above-described angle is also preferably set to 50° to 65°. At this time, it is preferable to have a configuration in which an observation of the projection image can be performed at an angle of 45° to 70°, preferably 50° to 65° on a side opposite to a side on which light is incident, with respect to the normal line of the selective reflection layer in the side on which projected light is incident.

The incident ray may be incident from any direction of upwards, downwards, rightwards, and leftwards of the windshield glass, and may be determined in accordance with a visible direction. For example, the projected light is preferably incident at an obliquely incidence angle from the bottom during the use.

In addition, it is preferable that the windshield glass (reflective layer) is disposed to reflect incident P-polarized light.

As described above, the projected light in a case of displaying the projection image in the HUD according to the embodiment of the present invention is preferably p-polarized light vibrating in the direction parallel to the incident surface.

In a case where the light emitted from the projector is not linearly polarized light, the light may be converted into p-polarized light by providing a linearly polarized light film (polarizer) on the light emitting side of the projector, or the light may be converted into p-polarized light by a known method of using the linearly polarized light film or the like on an optical path between the projector and the windshield glass. In this case, it is considered that a member converting projected light that is not linearly polarized light into p-polarization is also included in the projector of the HUD according to the embodiment of the present invention.

As described above, in the projector whose polarization direction is not uniform in the wavelength ranges of red light, green light, and blue light of the emitted light, the polarization direction is preferably adjusted in a wavelength selective manner, and light is incident in all color wavelength ranges as p-polarization.

In the HUD 20 according to the embodiment of the present invention, the projector 7 emits the projected light of which the main component is p-polarized light, but as described above, the s-polarized light component is mixed in the emitted light due to the influence of the mirror disposition or the like inside the projector, and the ratio of the s-polarized light component is 10% or more.

As mentioned above, the HUD (projector) may be a projection system in which a virtual image formation position is variable. The virtual image formation position is variable so that the driver can visually confirm the virtual image more comfortably and conveniently.

The virtual image formation position is a position at which the driver of the vehicle can visually confirm a virtual image, and for example, a position positioned 1000 mm or greater away from the front of the windshield glass as seen from a normal driver.

The present invention is basically configured as described above. Although the windshield glass and the head-up display system (HUD) according to the embodiments of the present invention have been described in detail above, the present invention is not limited to the above-described embodiments, and various improvements and modifications may be made without departing from the spirit of the present invention.

### EXAMPLES

The features of the present invention will be described in more detail with reference to the following examples. Materials, reagents, amounts of substances and percentages thereof, and operations illustrated in the following examples can be suitably changed within a range not departing from the gist of the present invention. Accordingly, the scope of the present invention is not limited to the following example.

### Example 1

### <Production of Windshield Glass>

A windshield glass was produced by producing laminated glass using an outer glass plate, an interlayer, and an inner glass plate as follows, and then attaching a linearly polarized light reflection film (reflective layer) and a retardation film (retardation layer) produced as follows with a pressure sensitive adhesive.

### (Production of Laminated Glass)

Float glass (manufactured by Central Glass Co., Ltd., FL2, visible light transmittance: 90%) having a height of 200 mm, a width of 300 mm, and a thickness of 2 mm was used as the outer glass plate and the inner glass plate. A PVB film (interlayer, manufactured by Sekisui Chemical Co., Ltd.) having a thickness of 0.76 mm was interposed between the outer glass plate and the inner glass plate, and the laminate was held at 90° C. and 10 kPa (0.1 atm) for 1 hour and then heated at 115° C. and 1.3 MPa (13 atm) for 20 minutes in an autoclave (manufactured by Kurihara Seisakusho Co., Ltd.) to remove air bubbles, thereby producing laminated glass.

### <Production of Linearly Polarized Light Reflection Film>

A linearly polarized light reflection film (linearly polarized light reflection layer) was produced as follows based on the method described in JP1997-506837A (JP-H9-506837A).

2,6-polyethylene naphthalate (PEN) and copolyester (coPEN) of naphthalate 70/terephthalate 30 were synthesized in a standard polyester resin synthesis kettle using ethylene glycol as a diol. Each of the single-layer films of PEN and coPEN was extrusion-molded, stretched at a stretching ratio of 5:1 at about 150° C., and heat-treated at about 230° C. for 30 seconds. It was confirmed that a refractive index of the PEN with respect to the slow axis (alignment axis) was about 1.86, a refractive index with respect to the transverse axis was 1.64, and a refractive index of the coPEN film was about 1.64.

Next, the stretching ratio was adjusted, and it was confirmed that a refractive index of the PEN with respect to the slow axis was about 1.71, a refractive index with respect to the transverse axis was 1.64, and a refractive index of the coPEN film was about 1.64. That is, a difference Δn between the refractive index of the optically anisotropic layer in the slow axis direction and the refractive index of the isotropic layer is 0.07.

Subsequently, PEN and coPEN were coextruded with a 25-slot supply block equipped with a standard extrusion die to form a layer that is composed of 16 layers with PEN and coPEN being alternately laminated and that has a film thickness illustrated in (1) of Table 1 below. Further, by repeating the same operation, 16 layers of PEN and coPEN having thicknesses shown in (2) to (6) of Table 1 below were alternately formed in order, thereby producing a laminate in which a total of 96 layers were laminated.

TABLE 1

| | (1) | (2) | (3) | | (4) | (5) | (6) |
|---|---|---|---|---|---|---|---|
| PEN | 65.8 nm | 80.4 nm | 95 | nm | 102.3 nm | 109.6 nm | 117.0 nm |
| coPEN | 68.6 nm | 83.8 nm | 99.1 | nm | 106.7 nm | 114.3 nm | 122.0 nm |

| | | | | | | |
|---|---|---|---|---|---|---|
| Number of layers | 16 layers | 16 layers | 16 layers | 16 layers | 16 layers | 16 layers |

Next, the stretched laminate was heat-treated in an air oven at about 230° C. for 30 seconds to produce a linearly polarized light reflection film. A thickness of the produced linearly polarized light reflection film was about 10 μm. In a case where a reflection spectrum of the linearly polarized light reflection film was measured with a spectrophotometer (manufactured by JASCO Corporation, V-670), a reflection spectrum having reflectance peaks at 450 nm, 550 nm, 650 nm, 700 nm, 750 nm, and 800 nm in a reflection band and a p-polarized light reflectance of 28% at an incidence angle of 65° was obtained.

### <Preparation of Retardation Layer>

### (Adjustment of Coating Liquid for Forming Retardation Layer)

The following components were mixed to prepare a retardation layer-forming coating liquid having the following composition.

(Retardation layer-forming coating liquid)

| | | |
|---|---|---|
| Mixture 1 | 100 | parts by mass |
| Fluorine-based horizontal alignment | 0.05 | parts by mass |
| agent 1 (alignment control agent 1) | | |
| Fluorine-based horizontal alignment | 0.01 | parts by mass |
| agent 2 (alignment control agent 2) | | |
| Polymerization initiator IRGACURE | 1.0 | part by mass |
| OXE01 (manufactured by BASF SE) | | |

| | |
|---|---|
| Solvent (methyl ethyl ketone) | the amount of a |
| | solute concentration |
| | of 20% by mass |

### Mixture 1

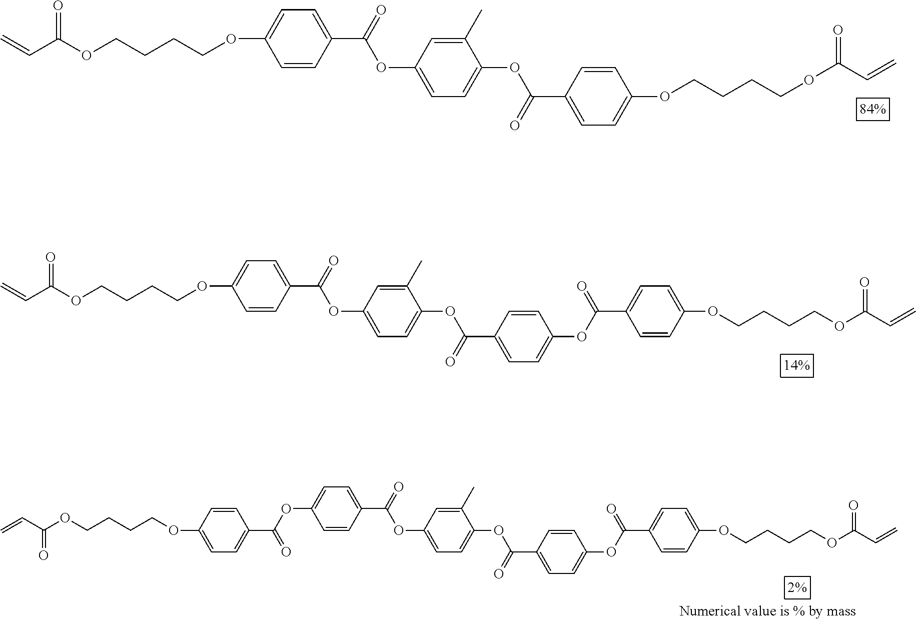

### Alignment Control Agent 1

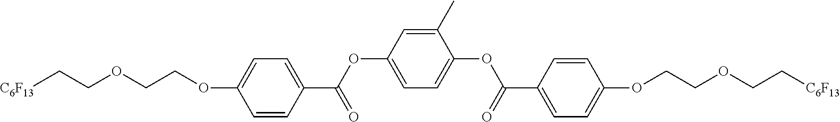

### Alignment Control Agent 2

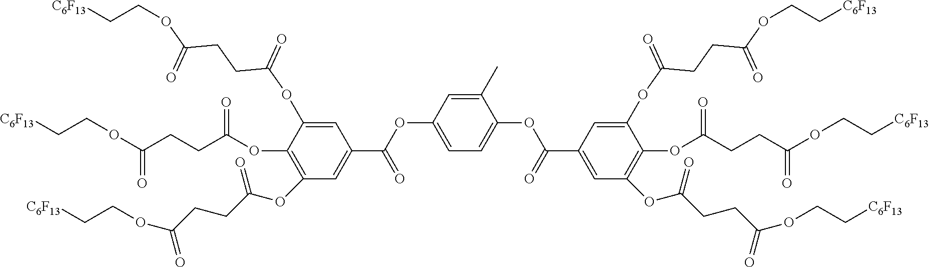

A cellulose acylate film (thickness: 40 μm) was used as a support, and the following alignment film was formed on the support, and then a retardation layer was formed.

### (Formation of Alignment Film)

The support was coated with a coating liquid for forming an alignment film, having the following formulation, using a wire bar coater at 24 mL/m², and dried with hot air at 100° C. for 120 seconds.

Composition of alignment film forming coating liquid

| | | |
|---|---|---|
| Modified polyvinyl alcohol illustrated below | 28 | parts by mass |
| Citric acid ester (AS3, manufactured by | 1.2 | parts by mass |
| Sankyo Chemical Co., Ltd.) | | |
| Photoinitiator (IRGACURE 2959, manufactured | 0.84 | parts by mass |
| by BASF SE) | | |
| Glutaraldehyde | 2.8 | parts by mass |
| Water | 699 | parts by mass |
| Methanol | 226 | parts by mass |

### (Modified Polyvinyl Alcohol)

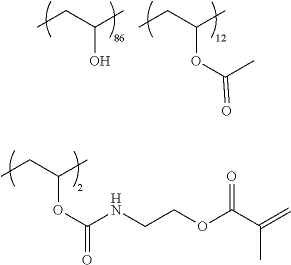

The formed coating film was subjected to a rubbing treatment (rayon cloth, pressure: 0.1 kgf (0.98 N), rotation speed: 1000 revolutions per minute (rpm), transportation speed: 10 m/min, number of times: 1 round trip) in a direction rotated clockwise by 6° with respect to the long side direction of the support to form an alignment film.

The surface of the alignment film on the support was coated with a coating liquid for forming a retardation layer using a wire bar, and then dried.

Next, the coated result was placed on a hot plate at 50° C. and irradiated with ultraviolet rays for 6 seconds by an electrodeless lamp “D bulb” (60 mW/cm²) manufactured by Fusion UV Systems Inc. in an environment with an oxygen concentration of 1000 ppm or less, and the liquid crystal phase was fixed. As a result, a retardation layer having a thickness adjusted to have a desired front phase difference, that is, a desired front retardation was formed.

In a case where the front retardation of the prepared retardation layer was measured with AxoScan, it was 330 nm.

Next, the linearly polarized light reflection film and the retardation layer were sequentially bonded to the prepared laminated glass using OCA (manufactured by NICHIEI KAKOH CO., LTD., MHM-UVC15).

The bonding of the linearly polarized light reflection film was performed such that the vertical direction (up-down direction) of the laminated glass and the direction of the reflection axis (slow axis of the optically anisotropic layer) coincided with each other. In addition, the bonding of the retardation layer was performed such that a direction rotated by 6° with respect to the vertical direction (up-down direction) of the laminated glass and the rubbing direction of the alignment film, that is, the slow axis coincided with each other. The vertical direction of the laminated glass here indicates the short side direction (side of 200 mm) of the glass.

As a result, a windshield glass having a layer configuration of outer glass plate/interlayer/inner glass plate/OCA/linearly polarized light reflection layer/OCA/retardation layer/cellulose acylate film is prepared.

### Example 1

### Example 2

In the same manner as in Example 1, after preparing the laminated glass, a reflective layer consisting of an inorganic dielectric layer was formed on a surface of the inner glass plate on a side opposite to the outer glass plate by magnetron sputtering. The inorganic film was formed with a configuration of inner glass plate/Si₃N₄ 12 nm/SiO₂ 179 nm/Si₃N₄ 54 nm/Ag 14 nm/Si₃N₄ 18 nm/SiO₂ 49 nm from the inner glass plate side, in which the high refractive index layer was Si₃N₄, the low refractive index layer was SiO₂, and the metal layer was Ag.

In a case where a reflection spectrum of the inorganic dielectric layer was measured with a spectrophotometer (manufactured by JASCO Corporation, V-670), a reflection spectrum having a p-polarized light reflectance of 27% at an incidence angle of 65° was obtained.

Next, in the same manner as in Example 1, after preparing the retardation layer, the retardation layer was bonded onto the inorganic dielectric layer of the prepared laminated glass with the inorganic dielectric layer by OCA (manufactured by NICHIEI KAKOH CO., LTD., MHM-UVC15).

The retardation layer was bonded such that a direction rotated by 6° with respect to the vertical direction (up-down direction) of the laminated glass coincided with the rubbing direction of the alignment film, that is, the direction of the slow axis.

As a result, a windshield glass having a layer configuration of outer glass plate/interlayer/inner glass plate/inorganic dielectric layer/OCA/linearly polarized light reflection layer/OCA/retardation layer/cellulose acylate film is prepared.

### Example 2

### Examples 3 to 17 and Comparative Examples 1 to 8

Windshield glasses of Examples 3 to 17 and Comparative Examples 1 to 8 are prepared in the same manner as in the preparation method of Example 1 or Example 2, except that the layer configuration, the presence or absence of the retardation layer, the type of the reflective layer, Re of the retardation layer, Rth of the retardation layer, and the angle of the retardation layer were changed as shown in Table 2. The configurations of Examples and Comparative Examples are shown in Table 2.

The retardation layers of Examples 4, 14, and 15 and Comparative Examples 7 and 8 are prepared in the same manner as the retardation layer of Example 1, except that the thicknesses were adjusted to be Re and Rth shown in Table 2.

In addition, in Example 16, a linearly polarized light reflection film and a retardation layer are prepared by the same method as in Example 1 before preparing the laminated glass, the linearly polarized light reflection film and the retardation layer were bonded in order onto the inner surface of the outer glass plate (the surface on the inner glass plate side) using OCA (manufactured by NICHIEI KAKOH CO., LTD., MHM-UVC15), and then the PVB film and the inner glass plate were laminated on the surface of the outer glass plate to which the linearly polarized light reflection film and the retardation layer were bonded, thereby preparing a laminated glass by the same method as in Example 1.

The linearly polarized light reflection film was bonded such that the vertical direction (up-down direction) of the laminated glass coincided with the direction of the reflection axis. In addition, the retardation layer was bonded such that the direction rotated by 6° with respect to the vertical direction (up-down direction) of the laminated glass coincided with the rubbing direction of the alignment film, that is, the slow axis.

That is, in Example 16, a windshield glass having a layer configuration of outer glass plate/OCA/linearly polarized light reflection layer/OCA/retardation layer/cellulose acylate film/interlayer/inner glass plate is prepared.

In addition, in Example 17, a reflective layer consisting of an inorganic dielectric layer was formed on the inner surface of the outer glass plate (the surface on the inner glass plate side) by the same method as in Example 2 before preparing the laminated glass, a retardation layer was bonded onto the inorganic dielectric layer using OCA (manufactured by NICHIEI KAKOH CO., LTD., MHM-UVC15), and then the PVB film and the inner glass plate were laminated on the surface of the outer glass plate to which the inorganic dielectric layer and the retardation layer were bonded, thereby preparing a laminated glass by the same method as in Example 1.

The inorganic dielectric layer was formed such that the vertical direction (up-down direction) of the laminated glass coincided with the direction of the reflection axis. In addition, the retardation layer was bonded such that the direction rotated by 6° with respect to the vertical direction (up-down direction) of the laminated glass coincided with the rubbing direction of the alignment film, that is, the slow axis.

That is, in Example 17, a windshield glass having a layer configuration of, outer glass plate/inorganic dielectric layer/OCA/retardation layer/cellulose acylate film/interlayer/inner glass plate is prepared.

TABLE 2

| | | | Retardation layer | | |
|---|---|---|---|---|---|
| | | | | | Angle of |
| | | | Re | Rth | slow axis |
| | Configuration | Type of reflective layer | [nm] | [nm] | [°] |
| Example 1 | Outer glass plate/Interlayer/Inner glass plate/OCA/Reflective | Linearly polarized light | 330 | 165 | 6 |
| | layer/OCA/Retardation layer | reflection layer | | | |
| Example 2 | Outer glass plate/Interlayer/Inner glass plate/Reflective | Inorganic dielectric layer | 330 | 165 | 6 |
| | layer/OCA/Retardation layer | | | | |
| Example 3 | Outer glass plate/Interlayer/Inner glass plate/OCA/Reflective | Linearly polarized light | 330 | 165 | 12 |
| | layer/OCA/Retardation layer | reflection layer | | | |
| Example 4 | Outer glass plate/Interlayer/Inner glass plate/Reflective | Inorganic dielectric layer | 300 | 150 | 6 |
| | layer/OCA/Retardation layer | | | | |
| Example 5 | Outer glass plate/Interlayer/Inner glass plate/OCA/Retardation | Linearly polarized light | 330 | 165 | 6 |
| | layer/OCA/Reflective layer | reflection layer | | | |
| Example 6 | Outer glass plate/Interlayer/Inner glass plate/OCA/Reflective | Linearly polarized light | 330 | 165 | 1 |
| | layer/OCA/Retardation layer | reflection layer | | | |
| Example 7 | Outer glass plate/Interlayer/Inner glass plate/OCA/Reflective | Linearly polarized light | 330 | 165 | 2 |
| | layer/OCA/Retardation layer | reflection layer | | | |
| Example 8 | Outer glass plate/Interlayer/Inner glass plate/OCA/Reflective | Linearly polarized light | 330 | 165 | 10 |
| | layer/OCA/Retardation layer | reflection layer | | | |
| Example 9 | Outer glass plate/Interlayer/Inner glass plate/OCA/Reflective | Linearly polarized light | 330 | 165 | 20 |
| | layer/OCA/Retardation layer | reflection layer | | | |
| Example 10 | Outer glass plate/Interlayer/Inner glass plate/OCA/Reflective | Linearly polarized light | 330 | 165 | 91 |
| | layer/OCA/Retardation layer | reflection layer | | | |
| Example 11 | Outer glass plate/Interlayer/Inner glass plate/OCA/Reflective | Linearly polarized light | 330 | 165 | 92 |
| | layer/OCA/Retardation layer | reflection layer | | | |
| Example 12 | Outer glass plate/Interlayer/Inner glass plate/OCA/Reflective | Linearly polarized light | 330 | 165 | 100 |
| | layer/OCA/Retardation layer | reflection layer | | | |
| Example 13 | Outer glass plate/Interlayer/Inner glass plate/OCA/Reflective | Linearly polarized light | 330 | 165 | 110 |
| | layer/OCA/Retardation layer | reflection layer | | | |
| Example 14 | Outer glass plate/Interlayer/Inner glass plate/OCA/Reflective | Linearly polarized light | 280 | 140 | 6 |
| | layer/OCA/Retardation layer | reflection layer | | | |
| Example 15 | Outer glass plate/Interlayer/Inner glass plate/OCA/Reflective | Linearly polarized light | 400 | 200 | 6 |
| | layer/OCA/Retardation layer | reflection layer | | | |
| Example 16 | Outer glass plate/OCA/Reflective layer/OCA/Retardation | Linearly polarized light | 330 | 165 | 6 |
| | layer/Interlayer/Inner glass plate | reflection layer | | | |
| Example 17 | Outer glass plate/Reflective layer/OCA/Retardation | Inorganic dielectric layer | 330 | 165 | 6 |
| | layer/Interlayer/Inner glass plate | | | | |
| Comparative | Outer glass plate/Interlayer/Inner glass plate/OCA/Reflective | Linearly polarized light | None | None | None |
| Example 1 | layer | reflection layer | | | |
| Comparative | Outer glass plate/Interlayer/Inner glass plate/Reflective layer | Inorganic dielectric layer | None | None | None |
| Example 2 | | | | | |
| Comparative | Outer glass plate/Interlayer/Inner glass plate/OCA/Reflective | Linearly polarized light | 330 | 165 | 0 |
| Example 3 | layer/OCA/Retardation layer | reflection layer | | | |
| Comparative | Outer glass plate/Interlayer/Inner glass plate/OCA/Reflective | Linearly polarized light | 330 | 165 | 25 |
| Example 4 | layer/OCA/Retardation layer | reflection layer | | | |
| Comparative | Outer glass plate/Interlayer/Inner glass plate/OCA/Reflective | Linearly polarized light | 330 | 165 | 90 |
| Example 5 | layer/OCA/Retardation layer | reflection layer | | | |
| Comparative | Outer glass plate/Interlayer/Inner glass plate/OCA/Reflective | Linearly polarized light | 330 | 165 | 115 |
| Example 6 | layer/OCA/Retardation layer | reflection layer | | | |
| Comparative | Outer glass plate/Interlayer/Inner glass plate/OCA/Reflective | Linearly polarized light | 260 | 130 | 6 |
| Example 7 | layer/OCA/Retardation layer | reflection layer | | | |
| Comparative | Outer glass plate/Interlayer/Inner glass plate/OCA/Reflective | Linearly polarized light | 430 | 215 | 6 |
| Example 8 | layer/OCA/Retardation layer | reflection layer | | | |

### [Evaluation of Brightness]

### <Evaluation of P-Polarized Light Reflectance>

Linearly polarized light in which the ratio of the p-polarized light component was 80% and the ratio of the s-polarized light component was 20% was incident from a direction of 65° with respect to the normal direction of the inner glass plate from the inner glass plate side, and the specularly reflected light (the direction of 65° with respect to the normal direction on the side opposite to the incidence direction in the incident surface) was measured for a reflectance spectrum with a spectrophotometer (manufactured by JASCO Corporation, V-670).

The s-polarized light ratio here is obtained by setting the polarization 30 of the projected light as a vector, setting the vertical direction 31 (the direction of the short side of 200 mm) of the windshield glass as the p-polarized light component, and setting the direction 32 (the direction of the long side of 300 mm) horizontal to the windshield glass as the s-polarized light component, as shown in FIG. 4. The ratio of the s-polarized light component is s-polarized light component/(s-polarized light component+p-polarized light component)×100%.

According to JIS R 3106, a projection image reflectance was calculated by multiplying the reflectance by a coefficient based on luminosity factor and an emission spectrum of the D65 light source in a wavelength range of 380 to 780 nm at intervals of 10 nm, and the projection image reflectance was evaluated as brightness. The brightness was evaluated according to the following evaluation standard.

### <Evaluation of Image Visibility>

The windshield glass was incorporated as a front glass of a vehicle, and an image was projected from a projector with a daytime road as a background to observe the HUD display image. In the HUD display image, characters were displayed in white, green, and red. The visibility of the display image was evaluated according to the following evaluation standard. In the evaluation of the brightness, the brightness is increased in a case where the reflection in the vicinity of a wavelength of 555 nm is strong. Therefore, in a case where the evaluation of the brightness is low, the visibility of red is more likely to be decreased than the visibility of green and white.

Evaluation standard for brightness (p-polarized light reflectance) and image visibility
A: 26% or more The white, green, and red characters could also be read.
B: 20% or more and less than 26% The white and green characters were visible, and the red characters could be read with some difficulty.
C: less than 20% The white and green characters were visible, but the red characters were faint and could not be read.

### [Evaluation of Double Image]

In the same manner as the evaluation of the p-polarized light reflectance, linearly polarized light in which the ratio of the s-polarized light component was 20% was incident on the windshield glass at an incidence angle of 65°, and a double image was visually confirmed using an image in which a lattice of white lines was drawn on a black background.

### Evaluation Standard of Double Image

A: The double image of the white line was not visible.
B: The double image of the white line was extremely faint. (Level at which there is no problem in practical use)
C: The double image of the white line was visible.

The results are shown in Table 3.

TABLE 3

| | Double image | Brightness |
|---|---|---|
| Example 1 | A | A |
| Example 2 | A | A |
| Example 3 | B | A |
| Example 4 | B | A |
| Example 5 | A | B |
| Example 6 | B | B |
| Example 7 | A | A |
| Example 8 | A | A |
| Example 9 | B | B |
| Example 10 | B | B |
| Example 11 | A | A |
| Example 12 | A | A |
| Example 13 | B | B |
| Example 14 | B | B |
| Example 15 | B | B |
| Example 16 | A | A |
| Example 17 | A | A |
| Comparative | C | B |
| Example 1 | | |
| Comparative | C | B |
| Example 2 | | |
| Comparative | C | B |
| Example 3 | | |
| Comparative | C | B |
| Example 4 | | |
| Comparative | C | B |
| Example 5 | | |
| Comparative | C | B |
| Example 6 | | |
| Comparative | C | B |
| Example 7 | | |
| Comparative | C | B |
| Example 8 | | |

As shown in Table 3, it was found that, in Examples of the present invention, good results were obtained for the double image as compared with Comparative Examples.

In addition, from the comparison between Examples 1 to 9 and 14 and 15 and Comparative Examples 3 and 4, and the comparison between Examples 10 to 13 and Comparative Examples 5 and 6, it was found that the angle of the slow axis of the retardation layer may be 1° or more and 20° or less, or 91° or more and 110° or less.

In addition, from the comparison between Example 1 and Examples 2 and 5, it was found that, in a case where the reflective layer is the linearly polarized light reflection layer, the brightness of the display image was further increased in a case where the retardation layer was closer to the vehicle interior side than the reflective layer.

In addition, from the comparison between Examples 1, 3, and 6 to 9, it was found that the angle of the slow axis of the retardation layer was preferably 2° or more and 10° or less.

In addition, from the comparison between Examples 10 to 13, it was found that the angle of the slow axis of the retardation layer was also preferably 92° or more and 100° or less.

In addition, from the comparison between Examples 2, 4, and 14 and 15, it was found that the front retardation of the retardation layer at a wavelength of 550 nm was preferably 320 nm or more and 350 nm or less.

In addition, from Examples 16 and 17, it was found that the same effect as that of the configuration in which the reflective layer and the retardation layer were disposed on the outer side surface of the laminated glass was obtained even in a configuration in which the reflective layer and the retardation layer were disposed between the outer glass plate and the inner glass plate.

From the above results, the effect of the present invention is clear.

The reflection film can be suitably used for an in-vehicle head-up display system (HUD) or the like.

### EXPLANATION OF REFERENCES

1: outer glass plate
2: inner glass plate
3: interlayer film
4: reflective layer
5: adhesion layer
6: retardation layer
7: projector
8: driver
9: incidence angle
10, 10b~10d: windshield glass
20: head-up display system (HUD)
30: polarization direction of incident ray
31: vertical direction of windshield glass
32: horizontal direction of windshield glass
40: direction of slow axis of retardation layer

What is claimed is:

1. A windshield glass comprising:
an outer glass plate;
a reflective layer consisting of a plurality of layers;
a retardation layer;
an interlayer; and
an inner glass plate,
wherein a front retardation of the retardation layer at a wavelength of 550 nm is 280 nm or more and 400 nm or less, and
an angle between a direction of a slow axis of the retardation layer and a vertical direction of the windshield glass is 1° or more and 20° or less, or 91° or more and 110° or less.

2. The windshield glass according to claim 1,
wherein the front retardation of the retardation layer at a wavelength of 550 nm is 320 nm or more and 350 nm or less.

3. The windshield glass according to claim 1,
wherein the angle between the direction of the slow axis of the retardation layer and the vertical direction of the windshield glass is 2° or more and 10° or less, or 92° or more and 100° or less.

4. The windshield glass according to claim 1,
wherein the reflective layer and the retardation layer are disposed between the outer glass plate and the inner glass plate, and
the retardation layer is disposed on an inner glass plate side with respect to the reflective layer.

5. The windshield glass according to claim 1,
wherein the reflective layer and the retardation layer are disposed between the outer glass plate and the inner glass plate, and
the retardation layer is disposed on an outer glass plate side with respect to the reflective layer.

6. The windshield glass according to claim 1,
wherein the reflective layer and the retardation layer are disposed on a surface side of the inner glass plate opposite to the outer glass plate, and
the retardation layer is disposed at a position spaced apart from the inner glass plate with respect to the reflective layer.

7. The windshield glass according to claim 1,
wherein the reflective layer and the retardation layer are disposed on a surface side of the inner glass plate opposite to the outer glass plate, and
the retardation layer is disposed on an inner glass plate side with respect to the reflective layer.

8. The windshield glass according to claim 1,
wherein the reflective layer is a reflective layer in which an inorganic layer is laminated.

9. The windshield glass according to claim 1,
wherein the reflective layer is a linearly polarized light reflection layer consisting of alternate lamination of an optically anisotropic layer and an optically isotropic layer.

10. A head-up display system comprising:
the windshield glass according to claim 1; and
a projector that irradiates an inner glass plate side of the windshield glass with projected light.

11. The head-up display system according to claim 10,
wherein the projected light of the projector includes an s-polarized light component and a p-polarized light component, and
a ratio of the s-polarized light component is 10% or more and 40% or less.

12. The windshield glass according to claim 2,
wherein the angle between the direction of the slow axis of the retardation layer and the vertical direction of the windshield glass is 2° or more and 10° or less, or 92° or more and 100° or less.

13. The windshield glass according to claim 2,
wherein the reflective layer and the retardation layer are disposed between the outer glass plate and the inner glass plate, and
the retardation layer is disposed on an inner glass plate side with respect to the reflective layer.

14. The windshield glass according to claim 2,
wherein the reflective layer and the retardation layer are disposed between the outer glass plate and the inner glass plate, and
the retardation layer is disposed on an outer glass plate side with respect to the reflective layer.

15. The windshield glass according to claim 2,
wherein the reflective layer and the retardation layer are disposed on a surface side of the inner glass plate opposite to the outer glass plate, and
the retardation layer is disposed at a position spaced apart from the inner glass plate with respect to the reflective layer.

16. The windshield glass according to claim 2,
wherein the reflective layer and the retardation layer are disposed on a surface side of the inner glass plate opposite to the outer glass plate, and
the retardation layer is disposed on an inner glass plate side with respect to the reflective layer.

17. The windshield glass according to claim 2,
wherein the reflective layer is a reflective layer in which an inorganic layer is laminated.

18. The windshield glass according to claim 2,
wherein the reflective layer is a linearly polarized light reflection layer consisting of alternate lamination of an optically anisotropic layer and an optically isotropic layer.

19. A head-up display system comprising:
the windshield glass according to claim 2; and
a projector that irradiates an inner glass plate side of the windshield glass with projected light.

20. The head-up display system according to claim 19,
wherein the projected light of the projector includes an s-polarized light component and a p-polarized light component, and
a ratio of the s-polarized light component is 10% or more and 40% or less.
